(19) United States
(12) Patent Application Publication
(10) Pub. No.: US 2026/0357813 A1
(43) Pub. Date: Nov. 12, 2026

(54) A MULTI-STAGE IN-LINE COMPRESSOR SYSTEM WITH DRY GAS SEALS AND METHOD

(71) Applicant: NUOVO PIGNONE TECNOLOGIE - S.R.L., Florence (IT)

(72) Inventors: Francesco CONFORTI, Florence (IT); Nico MONTAGNANI, Florence (IT); Vincenzo CIENTANNI, Florence (IT); Vincenzo PETRONE, Florence (IT); Francesco BARTOLINI, Florence (IT)

(21) Appl. No.: 19/129,960

(22) PCT Filed: Nov. 10, 2023
(86) PCT No.: PCT/EP2023/025473

§ 371 Date: May 14, 2025

(30) Foreign Application Priority Data
Nov. 16, 2022 (IT) 102022000023679

(51) Int. Cl. F04D 29/12; F04D 17/12

(52) U.S. Cl. CPC F04D 29/124; F04D 17/12; F05D 2270/306

(57) ABSTRACT

The compressor system comprises a multi-stage compressor and a seal gas supply system. The compressor comprises a low-pressure section and a high-pressure section in a straight-through configuration, and further comprises a shaft rotatingly housed in a compressor casing and having a low-pressure shaft end and a high-pressure shaft end. A low-pressure dry gas seal is arranged at the low-pressure shaft end and a high-pressure dry gas seal at the high-pressure shaft end. The seal gas supply system comprises: a seal gas booster; a first control valve adapted to control a seal gas flow from the seal gas booster to the low-pressure dry gas seal; and a second control valve adapted to control a seal gas flow from the seal gas booster to the high-pressure dry gas seal

### TECHNICAL FIELD

The present disclosure relates to turbomachines. More specifically, embodiments disclosed herein relate to systems comprising a multi-stage compressor, such as a multi-stage centrifugal compressor, including dry gas seals, and a seal gas supply system adapted to supply seal gas to the dry gas seals.

### BACKGROUND ART

Dry-gas seals are commonly used to reduce or prevent gas leakages around rotary shafts of turbomachines, such as centrifugal compressors. Dry gas seals require a continuous feed of seal gas, which shall be maintained also when the turbomachine is non-operating. See John S. Stahley, “Dry Gas Seals Handbook”, PennWell Corpo-ration, 2005; ISBN 1593700628.

Multi-stage compressors, in particular multi-stage centrifugal compressors, can comprise a low-pressure section and a high-pressure section, each of which comprises one or more impellers mounted for rotation on a rotary shaft. The low-pressure section includes a low-pressure suction and a low-pressure discharge. Process gas enters the low-pressure section at the low-pressure suction and is partially compressed through the stage(s) of the low-pressure section and discharged at the low-pressure discharge. The high-pressure section includes a high-pressure suction and a high-pressure discharge. The partially compressed gas from the low-pressure discharge enters the high-pressure section at the high-pressure suction and is further compressed and discharged at the high-pressure discharge.

Between the low-pressure discharge and the high-pressure suction, the partially compressed process gas can be cooled in an intercooler, to remove heat generated by the first compression and to improve the compressor efficiency.

The rotary shaft has two opposite ends supported in respective end bearings. Inboard of each bearing a respective dry gas seal is provided, which prevent process gas from leaking along the shaft towards the bearings.

The low-pressure section and a high-pressure section can be arranged in a so-called back-to-back arrangement, or in a so-called in-line or straight-through arrangement. In a back-to back arrangement the low-pressure discharge and the high-pressure discharge of the compressor are arranged between the low-pressure suction and the high-pressure suction, and the impellers of the low-pressure section and the impellers of the high-pressure sections are arranged back-to-back. An interstage seal is provided around the shaft, between the low-pressure section and the high-pressure section.

Conversely, in an in-line or straight-through arrangement, the impellers of the low-pressure section and the impellers of the high-pressure section are arranged in-line such that the low-pressure discharge and the high-pressure suction are arranged between the low-pressure suction and the high-pressure discharge. An interstage seal is provided around the shaft, between the low-pressure section and the high-pressure section. Moreover, a first balancing line extends from the most downstream stage of the low-pressure section to the most upstream stage of the low-pressure section. A second balancing line extends from the most downstream stage of the high-pressure section to the most upstream stage of the high-pressure section. When the compressor stops, two different settle-out pressures (shortly herein indicated as SOP) will establish in the low-pressure section and in the high-pressure section. The pressure in the two compressor sections will equalize only after a relatively long period of time, thanks to leakages through the inter-stage seal. As a consequence, the dry gas seals at the high-pressure end and at the low-pressure end of the compressor require seal gas at different pressure to properly buffer the dry gas seals. An external high-pressure seal gas source is therefore required.

The need for an external source is not always desirable and, in some circum-stances, an external source is not available.

### SUMMARY

To solve or alleviate the above-mentioned need for an external seal gas source, according to the present disclosure a novel compressor system is provided. The compressor system includes a rotary shaft housed for rotation in a compressor casing and having a low-pressure shaft end and a high-pressure shaft end. The compressor further includes a low-pressure compressor section having a low-pressure suction and a low-pressure discharge. A high-pressure compressor section of the compressor includes a high-pressure suction and a high-pressure discharge. The low-pressure compressor section and the high-pressure compressor section are configured in a straight-though arrangement, i.e., in an in-line configuration, wherein the low-pressure discharge and the high-pressure suction are arranged between the low-pressure suction and the high-pressure discharge.

The compressor further includes a low-pressure dry gas seal at the low-pressure shaft end and a high-pressure dry gas seal at the high-pressure shaft end.

To supply seal gas to the dry gas seals, the compressor system further includes a seal gas supply system. The seal gas supply system includes a seal gas booster. The seal gas booster comprises a booster inlet and a booster outlet. The booster inlet is fluidly coupled to the high-pressure discharge of the multistage compressor to receive process gas therefrom. The outlet of the seal gas booster is fluidly coupled to the low-pressure dry gas seal and to the high-pressure dry gas seal. A first seal gas feed line fluidly couples the booster outlet to the low-pressure dry gas seal and a first control valve is arranged in the first seal gas feed line to control the seal gas flow therethrough. A second seal gas feed line fluidly couples the booster outlet to the high-pressure dry gas seal. A second control valve is arranged in the second seal gas feed line. The second control valve controls the flow of seal gas towards the high-pressure dry gas seal.

According to another aspect, a compressor system is disclosed, comprising a multi-stage compressor and a seal gas supply system. The compressor includes a low-pressure section and a high-pressure section in a straight-through configuration. The compressor further includes a shaft rotatingly housed in a compressor casing and having a low-pressure shaft end and a high-pressure shaft end. A low-pressure dry gas seal is provided at the low-pressure shaft end and a high-pressure dry gas seal) at the high-pressure shaft end.

The seal gas supply system includes a seal gas booster comprising a booster inlet and a booster outlet. The booster inlet is fluidly coupled to the high-pressure discharge of the multi-stage compressor to receive process gas therefrom. The outlet of the seal gas booster is fluidly coupled to the low-pressure dry gas seal and to the high-pressure dry gas seal. A first control valve is arranged to control a seal gas flow from the seal gas booster to the low-pressure dry gas seal. A second control valve is arranged to control a seal gas flow from the seal gas booster to the high-pressure dry gas seal.

Further features and embodiments of the compressor systems outlined above are set out in the dependent claims.

According to yet another aspect, a method is disclosed herein, for supplying a seal gas to a low-pressure dry gas seal and to a high-pressure dry gas seal of a multistage compressor comprising a low-pressure section and a high-pressure section in a straight-through, i.e., in-line configuration. The method comprises the step of generating a flow of seal gas at a seal gas booster of a seal gas booster; wherein the seal gas booster comprises a seal gas booster inlet fluidly coupled with a delivery side of the multistage compressor to receive process gas therefrom. The method further comprises feeding a first seal gas flow from the seal gas booster outlet to the low-pressure dry gas seal through a first control valve and feeding a second seal gas flow from the seal gas booster outlet to the high-pressure dry gas seal through a second control valve. The method additionally includes the step of adjusting the first seal gas flow through the first control valve and adjusting the second seal gas flow through the second control valve.

In the present description and in the attached claims the terms “high-pressure” and “low-pressure” are used in a relative term. A “high-pressure section” of a compressor is understood herein as a section wherein the pressure of the process gas is higher than in a “low-pressure section”. This does not mean that the “high pressure” section or the “high-pressure discharge” are the section of a compressor system where the highest pressure of the process gas is achieved. Rather, the discharge end of the “high-pressure section” can be in turn fluidly coupled to a further compressor for additional compression of the process fluid. Similarly, the “low-pressure section” or “low-pressure suction” is not necessarily the most upstream section or the first suction side of a compressor train or system. Rather, the process gas entering the low-pressure section may in turn be delivered by a more upstream compressor.

### BRIEF DESCRIPTION OF THE DRAWINGS

Reference is now made briefly to the accompanying drawings, in which:

FIG. 1 is a schematic of an in-line multistage centrifugal compressor according to the present disclosure, including a low-pressure section and a high-pressure section; and

FIG. 2 is a schematic of the seal gas system providing seal gas to the dry gas seals of the compressor of FIG. 1.

### DETAILED DESCRIPTION

To remove the need for an external source of seal gas to feed seal gas when the in-line compressor is inoperative, according to the present disclosure a booster is provided, the inlet whereof can be connected to the high-pressure discharge of the compressor. A first control valve and a second control valve fluidly connect the booster to opposite dry gas seals. The two control valves are controlled independently from one another, such that seal gas at the proper pressure is provided for the two opposite dry gas seals at the two ends of the compressor shaft. Seal gas is thus delivered at the correct pressure at both the drive-end and non-drive-end of the compressor shaft.

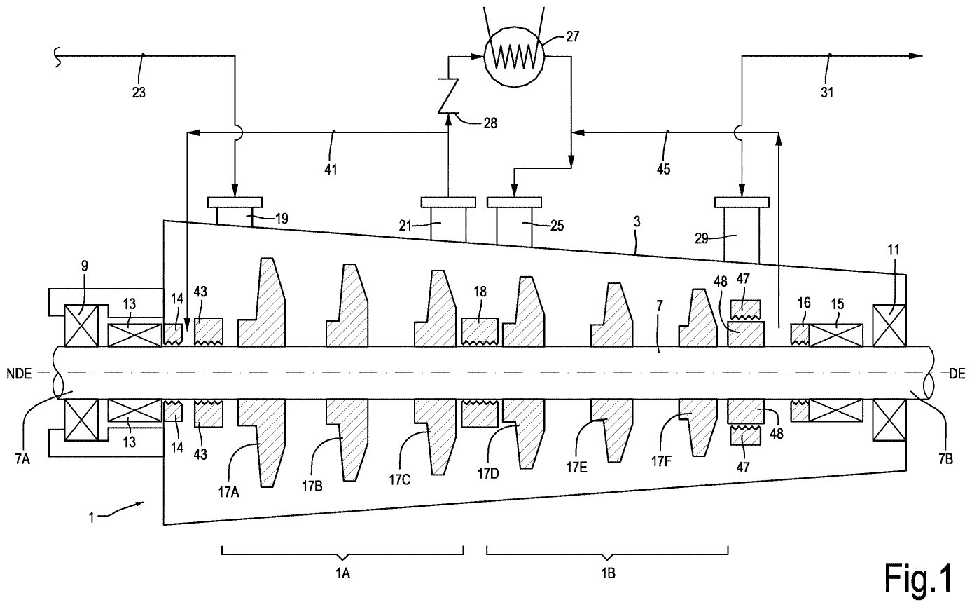

Turning now to the drawings, FIG. 1 schematically illustrates a multi-stage centrifugal compressor 1 having an in-line, i.e. straight-through configuration. The compressor 1 comprises a casing schematically shown at 3. A rotor 5 is housed for rotation in the casing 3. The rotor 5 comprises a rotation axis A-A and a rotary shaft 7. Two bearings 9, 11 rotatingly support the shaft 7 in the casing 3. The bearing 9 is arranged at a low-pressure shaft end 7A and the bearing 11 is arranged at a high-pressure shaft end 7B. The low-pressure shaft end 7A can be the so-called non-drive end of the shaft, i.e. the end of the shaft which is not connected to a compressor driver (not shown). The high-pressure shaft end 7B can be the so-called drive end of the shaft 7, i.e. the end of the shaft drivingly coupled to a driver, such as an electric motor, a gas or steam turbine or the like.

Inboard of the two bearings 9, 11 two dry gas seals 13, 15 are provided, which prevent process gas leakages from the interior of the compressor towards the bearings 9, 11. Herein the dry gas seal 13 will be referred to as the low-pressure dry gas seal and the dry gas seal 15 will be referred to as the high-pressure dry gas seal.

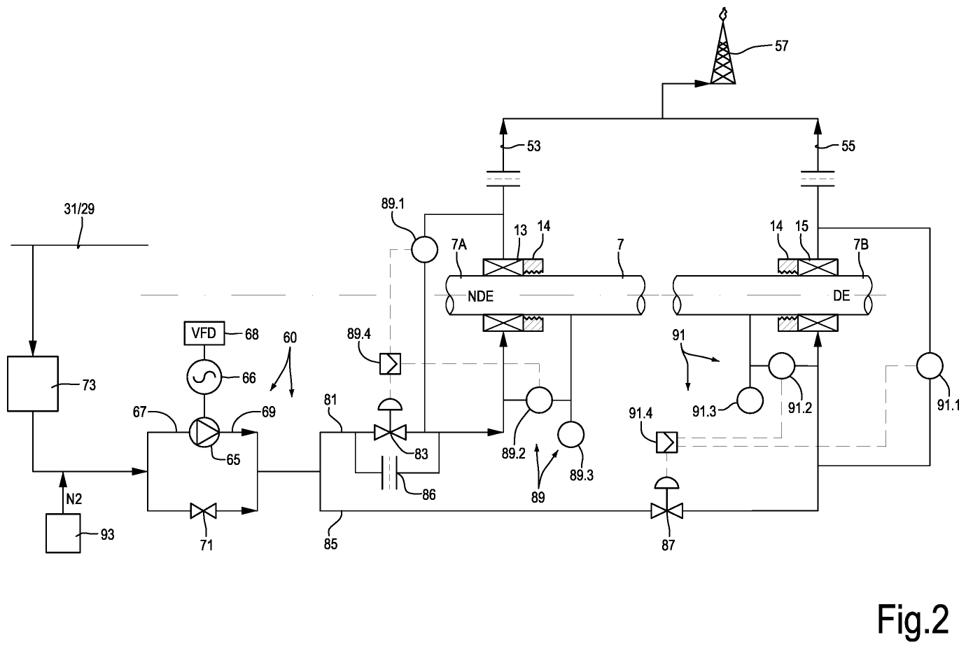

In general, the dry gas seals 13, 15 can have any configuration adapted for the nature of process gas to be sealed and for the kind of compressor 1. In some embodiments, the dry gas seals 13, 15 can be single dry gas seals. Preferably, the dry gas seals 13, 15 can be tandem dry gas seals, with or without an intermediate labyrinth, or double opposed dry gas seals, for instance. Each dry-gas seal 13, 15 includes at least a stationary primary ring and a rotating mating ring, which rotates integrally with the shaft 7. The stationary and rotating rings are not shown in the drawings. As will be clarified later on referring to FIG. 2, sealing gas is fed to each dry gas seal 13, 15 and seal gas venting from each dry gas seal is collected at a venting line. The dry gas seal 13 is provided with an inboard process labyrinth seal 14 and the dry gas seal 15 is provided with an in board process labyrinth seal 16.

The compressor 1 comprises a low-pressure compressor section 1A and a high-pressure compressor section 1B. In the embodiment of FIG. 1, the low-pressure compressor section 1A includes three impellers 17A, 17B, 17C. The high-pressure compressor section 1B includes three impellers 17D, 17E, 17F. The number of impellers in each compressor section is by way of example only. The impellers 17A-17F are arranged in an in-line, i.e. straight through configuration, the impeller 17A being the most upstream impeller, with respect to the process gas flow, at the lowest pressure and the impeller 17F being the most downstream impeller, at the highest pressure. An interstage seal 18 is arranged around the shaft 7 between the high-pressure compressor section 1 and the low-pressure compressor section 1A.

The low-pressure compressor section 1A includes a low-pressure suction 19 and a low-pressure discharge 21. The low-pressure suction 19 is fluidly coupled to a process gas supply line 23. The low-pressure discharge 21 is fluidly coupled to a high-pressure suction 25 through an intercooler 27 and a non-return valve 28. Ancillary components may be provided along the process gas path between the low-pressure discharge 21 and the high-pressure suction 25, such as a gas/liquid separator or the like, not shown. The high-pressure compressor section 1A further includes a high-pressure discharge 29, fluidly coupled to a process gas delivery line 31. The process gas delivery line 21 can be fluidly coupled to a higher-pressure compressor (not shown).

Process gas enters the compressor 1 from the process gas supply line 23 trough the low-pressure suction 19, is sequentially compressed through impellers 17A, 17B, 17C of the low-pressure compressor section 1A and is delivered to the intercooler 27 through the low-pressure discharge 21. Before being delivered to the high-pressure compressor section 1A, the partially compressed process gas is cooled in the intercooler 27, e.g. by heat exchange with air, water or another cooling fluid. Cooled and partially compressed process gas is further compressed through the impellers 17D, 17E and 17F of the high-pressure compressor section 1B and finally discharged through the high-pressure discharge 29.

The compressor 1 further comprises a low-pressure balancing line 41, which fluidly connects the low-pressure discharge 21 with an outboard side of an end seal 43 arranged inboard of the low-pressure dry gas seal 13. Specifically, the low-pressure balancing line 41 is connected to a volume between the process labyrinth seal 14 of the dry gas seal 13 and the end seal 43.

The compressor 1 further comprises a high-pressure balancing line 45, which fluidly connects the high-pressure suction 25 with an outboard side of a balance drum seal 47 arranged inboard of the high-pressure dry gas seal 15 and around a balance drum 48. Specifically, the high-pressure balancing line 45 is connected to a volume between the process labyrinth seal 16 of the dry gas seal 15 and the balancing drum 48.

The dry gas seals 13, 15 must be supplied with seal gas during normal operating conditions as well as when the compressor 1 is inoperative. During normal operation, process gas can be diverted from the delivery line 31 and treated in a seal gas treatment unit before being used as seal gas in the dry gas seals 13, 15. The seal gas is supplied at a pressure sufficient to buffer both dry gas seals 13, 15.

In case of compressor shut down, the process gas flow through the compressor stages is interrupted. A settle out pressure (SOP) will establish in the low-pressure compressor section 1A and a different, higher, settle out pressure will establish in the high-pressure compressor section 1B. The non-return valve 28 prevents backflow of the high-pressure process gas through the intercooler 27 from the high-pressure compressor section 1B towards the low-pressure compressor section 1A. Process gas will flow from the high-pressure compressor section 1B towards the low-pressure compressor section only through the interstage seal 18. The two SOPs will therefore balance only after a relatively long period of time. Consequently, after shut-down and for a relatively long period of time the gas pressure on the inboard side of the low-pressure dry gas seal 13 will be remarkably lower than the gas pressure on the inboard side of the high-pressure dry gas seal 15. In some examples, the gas pressure on the inboard side of the low-pressure dry gas seal 13 (i.e. inboard of the process labyrinth seal 14) will be 50% or less of the gas pressure on the inboard side of the high-pressure dry gas seal 15 (i.e. inboard of the process labyrinth seal 16). Seal gas at different pressures is required to buffer the two dry gas seals 13, 15.

In order to avoid the need for an external seal gas source to buffer the two dry gas seals during the SOPs balancing period following compressor shut down, the compressor system is provided with a novel seal gas supply system, which is schematically shown in FIG. 2 and omitted from FIG. 1 for the sake of clarity.

In FIG. 2, only the main components of the compressor 1 are shown, which are useful for a better understanding of the seal gas supply system of the present disclosure. The seal gas supply system is labeled 50 as a whole in FIG. 2. Schematically shown in FIG. 2 are the shaft 7, the low-pressure dry gas seal 13, the high-pressure dry gas seal 15, the end seal 43 and the balance drum seal 47. Also shown in FIG. 2 is a venting line 53, which collects the primary vent from the low-pressure dry gas seal 13, and a venting line 55, which collects the primary vent from the high-pressure dry gas seal 15. The seal gas vented by the dry gas seals 13, 15 can be recycled or delivered to a flare 57.

The seal gas supply system 50 comprises a seal gas booster 65 having a booster inlet 67 and a booster outlet 69. A bypass valve 71 can be arranged in parallel to the seal gas booster 65. The seal gas booster 67 can be driven by an electric motor 66 through a variable frequency drive 68, to adjust the flowrate of the seal gas booster 66 to the requirements of the dry gas seals 13, 15.

The booster 65 can comprise a regenerative compressor, which best suites the head and flowrate values involved. For instance, a suitable regenerative compressor can be one adapted to provide a flowrate ranging from 10 to 30 m³/h and a head up to about 2 bar.

The booster inlet 67 can be fluidly coupled to the high-pressure discharge 29 or to the process gas delivery line 31 through a seal gas treatment unit 73. The seal gas treatment unit 73 can be configured in a known manner, and may include filters and other ancillary devices to remove liquid or other impurities from the process gas before delivering the treated process gas to the suction side of the seal gas booster 65.

The booster outlet 69 is fluidly coupled to the low-pressure dry gas seal 13 and to the high-pressure dry gas seal 15 through respective control valves. More specifically, the booster outlet 69 is fluidly coupled to the low-pressure dry gas seal 13 through a first seal gas feed line 81 including a first control valve 83, arranged in the first seal gas feed line 81. Additionally, the booster outlet 69 is fluidly coupled to the high-pressure dry gas seal 15 through a second seal gas feed line 85 including a second control valve 87, arranged in the second seal gas feed line 85.

The first control valve 83 is controlled through a first valve control loop 89, which can be a pressure control loop or a flowrate control loop, for instance. Similarly, the second control valve 87 is controlled through a second valve control loop 91, which can be a pressure control loop or a flowrate control loop.

In some embodiments, the fist valve control loop 89 can comprise a first differential pressure sensor 89.1 adapted to detect the differential pressure between the venting line 53 and a point downstream the first control valve 83. The first valve control loop 89 can further comprise a second differential pressure sensor 89.2 between a point downstream the first control valve 83 and a point between the inboard labyrinth seal 14 and the end seal 43. The first valve control loop 89 can further include a pressure sensor 89.3. A comparator 89.4 compares the signals from the first differential pressure sensor 89.1 and the second differential pressure sensor 89.2. These signals are proportional to the difference between respective set points and the actual pressure differential detected by the sensor. The signal having the highest value can be selected as the control signal for the first control valve 83.

Similarly, in some embodiments, the second valve control loop 91 can comprise a first differential pressure sensor 91.1 adapted to detect the differential pressure between the venting line 55 and a point downstream the second control valve 87. The second valve control loop 91 can further comprise a second differential pressure sensor 91.2 between a point downstream the second control valve 87 and a point between the inboard labyrinth seal 16 and the balance drum seal 47. The second valve control loop 91 can further include a pressure sensor 91.3. A comparator 91.4 compares the signals from the first differential pressure sensor 91.1 and the second differential pressure sensor 91.2. These signals are proportional to the difference between respective set points and the actual pressure differential detected by the sensor. The signal having the highest value can be selected as the control signal for the second control valve 87.

After shutdown of the compressor, the SOP inside the low-pressure section 1A and the high-pressure section 1B differ substantially, e.g. by more than 50%. At this point in time, the first control valve 83 can be closed, or only partly open, e. g between 10 and 20%, since the pressure inboard the dry gas seal 13 is low. Conversely, the second control valve 87 will be fully open or almost fully open, for instance open between 60% and 80%. The difference between the two SOPs in the low-pressure section 1A and high-pressure section 1B tend to become smaller due to leakages through the interstage seal 18, i.e., the SOP in the high-pressure section 1B will drop and the SOP in the low-pressure section 1B will increase. The change in SOP is detected by the differential pressure sensors mentioned above and the control loops 89 and 91 will cause consequently the second control valve 87 to gradually close and the first control valve 83 to gradually open.

Thus, with the seal gas supply system 60 described above the first and second control valves 83, 87 can be controlled, one independently from the other, to adjust the seal gas flowrate of the low-pressure dry gas seal 13 and of the high-pressure dry gas seal 15 to balance the change in pressure on the inboard side of the respective dry gas seals 13, 15. Specifically, gas leaking through the interstage seal 18 will tend to equalize the gas pressure inside the low-pressure section and the high-pressure section of the compressor, thus causing an increase of the pressure inboard of the low-pressure dry gas seal 13 and a reduction of the pressure inboard of the high-pressure dry gas seal 15. As a consequence, the seal gas flowrate towards the high-pressure dry gas seal 15 will drop while the seal gas flowrate towards the low-pressure dry-gas seal will increase.

The total flowrate (i.e. the sum of seal gas flowrate towards the low-pressure dry gas seal 13 ad the seal gas flowrate towards the high-pressure dry gas seal 15) is delivered by the seal gas booster 65 and the partial flowrate toward each dry gas seal 13, 15 is adjusted by the respective control valve 83, 87, which are in turn controlled by the respective first control loop 89 and second control loop, 91, taking into account the pressure inboard of each dry gas seal.

For instance, after shut down, when different SOPs will establish in the low-pressure compressor section 1A and in the high-pressure compressor section, respectively the second control valve 87 (which supplies seal gas to the high-pressure dry gas seal 15) can be open more than 60%, while the first control valve 83 (which supplies seal gas to the low-pressure dry gas seal 13) can be partly closed e.g. open to less than 25%. In some embodiments, an orifice 86 in parallel to the first control valve 83 can be provided. In such case, the starting position of the first control valve 83 can be fully closed.

While the SOP inside the low-pressure compressor section 1A increases and the SOP inside the high-pressure compressor section decreases due to leakages through the interstage seal 18, the seal gas flowrate through the second control valve 87 will reduce and the seal gas flow rate through the first control valve 83 will increase. When the two SOPs are balanced, i.e. once the same pressure is established in the low-pressure compressor section 1A and in the high-pressure compressor section 1B, the seal gas flowrates through the first control valve 83 and the second control valve 87 will become substantially equal to one another.

A separate source of seal gas, for example an inert gas such as nitrogen, can further be coupled to the inlet 67 of the seal gas booster, as schematically shown at 93 in FIG. 2.

Exemplary embodiments have been disclosed above and illustrated in the accompanying drawings. It will be understood by those skilled in the art that various changes, omissions and additions may be made to that which is specifically disclosed herein without departing from the scope of the invention as defined in the following claims.

1. A compressor system comprising:
a multi-stage compressor comprising:
a rotary shaft housed for rotation in a compressor casing and having a low-pressure shaft end and a high-pressure shaft end;
a low-pressure compressor section having a low-pressure suction and a low-pressure discharge;
a high-pressure compressor section having a high-pressure suction and a high-pressure discharge;
wherein the low-pressure compressor section and the high-pressure compressor section are configured in a straight-though arrangement, the low-pressure discharge and the high-pressure suction being arranged between the low-pressure suction and the high-pressure discharge;
a low-pressure dry gas seal at the low-pressure shaft end; and
a high-pressure dry gas seal at the high-pressure shaft end;
a seal gas supply system, comprising:
a seal gas booster having a booster inlet and a booster outlet;
wherein the booster inlet is fluidly coupled to the high-pressure discharge of the multistage compressor to receive process gas therefrom;
a first seal gas feed line fluidly coupling the booster outlet to the low-pressure dry gas seal; a first control valve arranged in said first seal gas feed line;
a second seal gas feed line fluidly coupling the booster outlet to the high-pressure dry gas seal; and
a second control valve arranged in the second seal gas feed line.

2. The compressor system of claim 1, further comprising a seal gas treatment unit between the high-pressure discharge of the multistage compressor and the booster inlet.

3. The compressor system of claim 1, further comprising: a first valve control loop adapted to control the first control valve; and
a second valve control loop adapted to control the second control valve.

4. The compressor system of claim 3, wherein the first valve control loop and the second valve control loop are pressure control loops, or flow-rate control loops.

5. The compressor system of claim 1, further comprising: an inter-phase seal around the rotary shaft between the low-pressure compressor section and the high-pressure compressor section; and a balance drum arranged at the high-pressure end of the rotary shaft;
wherein an outboard side of the balance drum is fluidly coupled to the low-pressure suction.

6. A compressor system comprising:
a multi-stage compressor comprising:
a low-pressure section and a high-pressure section in a straight-through configuration;
a shaft rotatingly housed in a compressor casing and having a low-pressure shaft end and a high-pressure shaft end;
a low-pressure dry gas seal at the low-pressure shaft end; and
a high-pressure dry gas seal at the high-pressure shaft end;
a seal gas supply system comprising:
a seal gas booster having a booster inlet and a booster outlet;
wherein the booster inlet is fluidly coupled to the high-pressure discharge of the multistage compressor to receive process gas there-from;
a first control valve adapted to control a seal gas flow from the seal gas booster to the low-pressure dry gas seal; and
a second control valve adapted to control a seal gas flow from the seal gas booster to the high-pressure dry gas seal.

7. The compressor system of claim 6, further comprising one or more of the features of the seal gas treatment unit, the first valve control loop, and the second valve control loop, the interphase seal, or the balance drum.

8. A method for supplying a seal gas to a low-pressure dry gas seal and to a high-pressure dry gas seal of a multistage compressor comprising a low-pressure section and a high-pressure section in a straight-through con-figuration; wherein the method comprises the following steps:
generating a flow of seal gas at a seal gas booster outlet of a seal gas booster;
wherein the seal gas booster comprises a seal gas booster inlet fluidly coupled with a delivery side of the multistage compressor to receive process gas therefrom;
feeding a first seal gas flow from the seal gas booster outlet to the low-pressure dry gas seal through a first control valve; feeding a second seal gas flow from the seal gas booster outlet to the high-pressure dry gas seal through a second control valve; and adjusting the first seal gas flow through the first control valve and adjusting the second seal gas flow through the second control valve.

9. The method of claim 8, further comprising the step of shutting down the multistage compressor, and wherein after compressor shut down, the step of ad-justing the first seal gas flow through the first control valve and the second seal gas flow through the second control valve includes the steps of increasing the seal gas flow through the first control valve and decreasing the seal gas flow through the second control valve while a settle-out pressure in the low-pressure compres-sor section increases and a settle-out pressure in the high-pressure compressor section decreases.
